(19) United States
(12) Patent Application Publication
(10) Pub. No.: US 2006/0151989 A1
(43) Pub. Date: Jul. 13, 2006

(54) Embossed optically variable devices

(76) Inventors: Sani Muke, Healesville (AU); Wayne Kevin Jackson, Reservoir (AU)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/530,665

(22) PCT Filed: Oct. 7, 2003
(86) PCT No.: PCT/AU03/01316

§ 371 Date: Oct. 5, 2005

(30) Foreign Application Priority Data
Oct. 7, 2002 (AU) 2002951870
Jul. 16, 2003 (AU) 2003903687

(51) Int. Cl. B42D 15/00

(52) U.S. Cl. 283/67

(57) ABSTRACT

A security device (3) and a method of forming a security device (3) is provided in which a sheet (1) has a substantially transparent or translucent layer (10) and a reflective layer (11) with at least part of the reflective layer (11) being visible through the transparent or translucent layer (10) from a first side of the sheet (1). The sheet (1) is blind embossed from the first side through the transparent or translucent layer (10) and onto the reflective layer (11) to form a transitory embossed image (3). The transitory embossed image (3) may be provided in a window or half-window (2) formed by applying one or more opacifying layers (14) to the substrate (10) except in the area containing the reflective layer (11) and transitory embossed image (3) on one or both sides of the substrate (10). In one embodiment, the reflective layer is a highly reflective metallic ink (11). In another embodiment, the reflective layer is an optically variable pigment (11a) which provides a colour shift between two distinct colours with the colour shift dependent upon viewing angle. In further embodiments, the transitory embossed image (41, 42, 43) comprises macro-embossings (52, 53) with micro-embossings (54, 55) formed on the sides of the macro-embossings (52, 53). Each of the embodiments of transitory embossed images produces unusual visual switching effects which cannot be reproduced by photocopying and which are difficult to counterfeit.

### FIELD OF THE INVENTION

The present invention relates to methods of forming security devices and to security devices formed thereby. In particular, although not exclusively, the invention relates to security devices which may be provided on security documents or tokens such as banknotes, cheques, travellers cheques, credit cards, identification cards, passports, stock and share certificates, tickets and the like, and is particularly concerned with providing a security device for security documents which is readily discernible only at certain viewing angles and which is difficult to copy or counterfeit.

### BACKGROUND TO THE INVENTION

The use of transitory embossed images as security devices in security documents has been previously proposed. For example, U.S. Pat. No. 5,199,744 discloses a security device formed by embossing a substrate with a transitory image in association with an embossed non-transitory linear area which is visible from substantially all viewing angles. The transitory image may be a transient image which is one that can be seen when viewing the substrate normally but not when the substrate is viewed off normal, or a latent image which is one that cannot be seen when viewing the substrate normally but which can be seen when the substrate is viewed from certain off normal angles. In U.S. Pat. No. 5,199,744, the surface to be embossed may be specularly reflecting, such as provided by a metallic ink. Also, the security device of U.S. Pat. No. 5,199,744 requires the embossed non-transitory linear area to circumscribe or define an identifiable portion of the design element.

Although U.S. Pat. No. 5,199,744 provides a transitory embossed security device which has some unusual visual effects, it is an object of this invention to achieve more striking visual effects.

In a more preferred form of the invention, the sheet may include a transparent substrate with one or more opacifying layers applied to at least the first side except in the region of said portion of the transparent substrate, to form a window on the first side of the sheet. An appropriate substrate is a laminated film of biaxially oriented polymeric material, such as disclosed in Australian patent no 558476 (or U.S. Pat. No. 4,536,016). Instead of applying the opacifying layers to the substrate, means may be provided to selectively opacify regions within the substrate. A polymer substrate is preferred because of the smoother surface in comparison to paper.

Alternatively, transparent polymeric card materials such as polycarbonate or polyvinylchloride (PVC) may be used as the substrate. The reflective layer may be applied to one side or embedded into the transparent polymeric substrate.

The second, reverse, side of the sheet may also be at least partly opacified, particularly in the case where a transparent substrate is used. The second side may be opacified except in the region of said portion of the transparent substrate to form a window on the second side of the sheet in register with the window formed on the first side of the sheet. Alternatively, the opacification on the second side may form a complete covering to cover the reflective layer so that the window on the first side forms “a half window”. The opacification may take place before or after the step of blind embossing. Opacification on the second side results in the reflective layer being embedded between the at least one opacifying layer and the transparent layer, protecting the reflective layer against chemical and physical attack.

The embossed transitory image may be provided wholly within the window or “half window”. Alternatively, the embossed transitory image may extend over at least part of the window and over part of an opaque region adjacent to or surrounding the window.

In an alternative form of the invention, the substantially transparent or translucent layer may be formed by means of a coating applied to a substrate. The substrate may constitute the reflective layer, for example a layer of foil. Alternatively, the coating may be applied to a separate substrate layer, in which case the coating is applied over the reflective layer to sandwich the reflective layer between the coating and the substrate.

A suitable coating may comprise UV curable gloss overcoat varnish which could be printed using offset or gravure printing. Preferably such coatings should have a relatively high reflectance of at least 70 gloss units and have a suitable adhesion to the reflective layer. Opacifying inks may be applied over the coating to create a window on the first side of the sheet.

A substrate per se is not necessarily essential to the present invention. A bonded transparent layer and reflective layer may together be of sufficient strength to undergo the embossing process. For example, the sheet may simply comprise a transparent layer in the form of a film of transparent material bonded to a layer of foil. Alternatively, the metal reflective layer may be sputtered onto the transparent layer.

Irrespective of the medium used to create the substantially transparent or translucent layer, preferably it is has a glossy surface, the reflection from which enhances the effect created by the embossing in the reflective surface of the reflective layer. The transparent layer preferably has a gloss value of at least 75, and more preferably falling substantially within the range from about 80 to about 90. These values are measured using a Gardener micro-tri-gloss meter at an angle of 45°.

An additional benefit of the substantially transparent or translucent layer is that it provides a protective coating over the reflective layer against chemical or physical attack.

The reflective layer is preferably also highly reflective. The reflective layer preferably has a gloss value of at least 60 units, as measured with a Gardener micro-tri-gloss meter at an angle of 45° As mentioned above, the reflective layer may be comprised of a reflective material such as metal foil applied to a substrate.

Alternatively, the reflective layer may be formed by printing with reflective ink. A preferred printing method is the gravure printing process which can achieve a layer of ink of two-three microns in thickness (dry weight). Where the security device is formed on a larger document such as bank note, the printing of the reflective layer by the gravure process may be conducted when other parts of the security document are being printed. The reflective layer can also be printed with the silk screen process.

The reflective layer may comprise metallic material applied to a substrate such as by sputtering or a vapour deposition process. Alternatively, the substrate itself could be made of a suitable material such as a foil.

The extent of the reflective layer is preferably sufficient to contain the whole of the embossed image. Where the security device is incorporated into a security document or article, the reflective layer may constitute a patch or a specific region on the document or article. The reflective layer is preferably continuous within the patch or region.

The reflective ink may comprise a metallic ink which is highly reflective, such as a silver or gold metallic ink, or a nacreous or pearlescent pigment such as iriodin. Iriodin is a Registered Trade Mark of Merck KGaA.

The reflective ink may be of the type comprising an optically variable pigment. The term optically variable pigment as used herein refers to a coating composition, such as an ink, which provides a colour shift between two distinct colours with the colour shift being dependent upon the viewing angle. An example of such an optically variable ink (OVI) is described in EP 0,984,043 of SICPA Holding SA, and OVI is a Registered Trade Mark of SICPA Holding SA.

One example of an optically variable pigment is a green/blue OVI which appears green when viewed in reflection at viewing angles around the normal to the substrate, and which appears blue when viewed at acute angles to the plane of the substrate. Another example of an optically variable coating is one which changes colour from gold when viewed at normal incidence, to green when viewed obliquely.

Combinations of various reflective inks may be used to make up the reflective layer. For example, a secondary image may be created within the reflective layer using two different types of reflective inks.

The blind embossing may be conducted by a stamping operation. Preferably, the blind embossing may be conducted by the process of intaglio printing, except without ink. This enables a deeper emboss to be achieved than can be achieved with ink. Where the security device is incorporated into a larger document or article such as a bank note, the blind embossing operation may use the same intaglio printing plate to emboss the security device as is used to print other portions of the document or article, except that the blind embossing is carried out by un-inked portions of the plate. The printing and embossing could occur in line on a continuous web based process as used in the bank note production and labels industry.

The embossed image may comprise a set of lines or dots.

It has also been discovered that unusual visual effects can be obtained when the transitory embossed image includes a first set of embossed lines or dots extending in one direction, and a second set of embossed lines or dots extending in a different direction. The first set of embossed lines or dots may form a first part or a background of the transitory embossed image and the second set of embossed lines or dots may form a second part of the transitory embossed image, eg indicia, such as numbers and/or lettering, or a picture. In one preferred embodiment, the second set of embossed lines or dots extends substantially perpendicularly to the first set of embossed lines or dots.

Alternatively, the pattern of the embossing may include indicia such as letters or numbers. Alternatively, the embossing pattern may comprise a device such as a logo or a crest. In such a pattern, the embossed image may be formed against a plain non-embossed background.

In accordance with a further aspect of the invention, there is provided a method of forming a security device including: providing a sheet including a reflective layer; and blind embossing the sheet in the region of the reflective layer to form a transitory embossed image; wherein the transitory embossed image comprises a first embossing having a predetermined feature and a second embossing of smaller dimensions formed on said predetermined feature of said first embossing, said first embossing being formed to hide and reveal said second embossing at predetermined viewing angles.

Preferably, the sheet includes a substrate and is embossed through the substrate layer and onto the reflective layer. The substrate preferably includes a transparent or translucent layer, and the arrangement of the layers may be such that the reflective layer is visible through the transparent or translucent layer. However, the arrangement may be such that the transparent or translucent layer is disposed behind the reflective layer, relative to the viewing direction.

The first embossing may comprise a set of spaced first features having sides and the second embossing is formed on the sides of the first features. For example, the first embossing may comprise a set of spaced lines or grooves. These lines or grooves may be parallel.

The second embossing preferably comprises a first set of image embossings disposed on corresponding first sides of the first features and a second set of image embossings disposed on corresponding second sides of the first features to form a first image corresponding to the first set of image embossings at a viewing angle facing the first sides and to form a second image corresponding to the second set of image embossings at a viewing angle facing the second sides.

The first image may be different to the second image.

Alternatively, the first embossing may comprise a set of spaced first features having sides with lower portions of the first embossing being disposed between the spaced first features, the second embossing being formed between the first features on the lower portions. In other words, the second embossing may be formed in the troughs of a set of raised lines.

Any of the features described in connection with any of the foregoing aspects of the invention may be incorporated into the aspect above.

In accordance with still a further aspect of the invention, there is provided, a security device comprising: a sheet including a reflective layer in the region of the reflective layer, and a blind embossed transitory image formed in the sheet, wherein the transitory embossed image comprises a first embossing having a predetermined feature and a second embossing of smaller dimensions formed on said predetermined feature of said first embossing, said first embossing being formed to hide and reveal said second embossing at predetermined viewing angles.

Any of the features described in connection with any of the foregoing aspects of the invention may be incorporated into the aspect above.

In accordance with a still further aspect of the invention, there is provided a method of forming a security device including: providing a substantially transparent or translucent layer; blind embossing the substantially transparent or translucent layer through the transparent or translucent layer to produce an embossment in the layer; applying a reflective layer to the substantially transparent or translucent layer at least in part register with the embossment, wherein the transitory embossed image comprises a first embossing having a predetermined feature and a second embossing of smaller dimensions formed on said predetermined feature of said first embossing, said first embossing being formed to hide and reveal said second embossing at predetermined viewing angles.

Any of the features described in connection with any of the foregoing aspects of the invention may be incorporated into the aspect above.

According to another aspect of the invention there is provided a security document or device comprising a substrate, a layer of optically variable pigment applied to an area of the substrate, and an embossed transitory image formed by an embossing in the area of optically variable pigment, wherein the embossed transitory image includes a first set of lines or dots extending in one direction and a second set of lines or dots extending in a different direction.

The term optically variable pigment as used herein refers to a coating composition, such as an ink, which provides a colour shift between two distinct colours with the colour shift being dependent upon the viewing angle. An example of such an optically variable ink (OVI) is described in EP 0,984,043 of SICPA Holding SA, and OVI is a Registered Trade Mark of SICPA Holding SA.

One example of an optically variable pigment is a green/blue OVI which appears green when viewed in reflection at viewing angles around the normal to the substrate, and which appears blue when viewed at acute angles to the plane of the substrate. Another example of an optically variable coating is one which changes colour from gold when viewed at normal incidence, to green when viewed obliquely.

While the optically variable pigment and the embossed transitory image may be provided on an opaque substrate, the optically variable pigment and the embossed transitory image are preferably applied at least partly in a transparent or translucent window of the substrate. The substrate may be formed from a transparent plastics material to which at least one opacifying coating has been applied, except in the region of the transparent window. Alternatively, a transparent plastics substrate could be inserted as a window in a security document formed from paper or other material.

According to another aspect of the invention there is provided a method of forming an optically variable transitory embossed image for a security document or device comprising the steps of applying an optically variable pigment over an area of a substrate, and embossing said area of the substrate to form an embossed transitory image, wherein the embossed transitory image includes a first set of lines or dots extending in one direction and a second set of lines or dots extending in a different direction.

In a particularly preferred embodiment, the optically variable pigment and the embossed transitory image are applied over at least part of a transparent window and over part of an opaque region surrounding the transparent window.

In another preferred embodiment, the optically variable pigment is applied to one side of the substrate and the embossing step is performed by embossing the opposite side of the substrate.

Surprisingly, it has been found that for a transitory image formed from a set of embossed lines or dots on an unembossed area of optically variable pigment, the part of the image formed by the embossed lines appears substantially the same colour as the unembossed area of the optically variable pigment when viewed in reflection at typical oblique viewing angles (say 30° from normal) to form a latent image but as the viewing angle changes to more oblique viewing angles, although the colour of the optically variable pigment changes (eg from green to blue), the part of the transitory image formed by embossed lines extending perpendicularly to the viewing direction does not change colour (eg stays green) and so differs from the changed colour of optically variable pigment at oblique viewing angles to reveal the latent image at that angle. The transitory embossed image is preferably substantially hidden when viewed in light transmitted through the substrate.

It has also been discovered that unusual visual effects are obtained when the transitory embossed image includes a first set of embossed lines or dots extending in one direction, and a second set of embossed lines or dots extending in a different direction as per the claimed invention. The first set of embossed lines or dots may form a first part or a background of the transitory embossed image and the second set of embossed lines or dots may form a second part of the transitory embossed image, eg indicia, such as numbers and/or lettering, or a picture. In one preferred embodiment, the second set of embossed lines or dots extends substantially perpendicularly to the first set of embossed lines or dots.

Further, different unusual colour effects provided by the transitory embossed image can be observed when the image is viewed in reflection through rotations in different planes perpendicular to the substrate and also through a rotation in a plane substantially parallel to the substrate, with different parts of the image appearing either the same colour or a different colour as the optically variable pigment at different viewing angles, so that different parts of the transitory embossed image appear to switch on and off in different colours at different viewing angles.

In accordance with yet another aspect of the present invention, there is provided a security document or device comprising a substrate, a layer of optically variable or reflective coating applied to an area of the substrate, and an embossed transitory image formed by embossing in the area of the optically variable or reflective coating, wherein the security document is formed with a transparent window and the embossed transitory image is at least partly disposed in the transparent window.

Any of the features described above in connection with the previous aspects of the invention may be incorporated into the above aspect of the invention.

### BRIEF DESCRIPTION OF THE DRAWINGS

The present invention will now be described in more detail, by way of example only, with reference to the accompanying drawings in which:

FIG. 1 is a schematic plan view of a security document incorporating a transitory embossed image;

FIG. 2 is an enlarged view of the optically variable transitory embossed image of FIG. 1;

FIG. 3 is a schematic view of the security document of FIG. 1 being viewed in reflection from a first viewing angle;

FIG. 4 is a schematic view of the security document being viewed in reflection from a more oblique viewing angle;

FIG. 5 is a schematic view of the security document being viewed in reflection from another oblique viewing angle;

FIG. 6 is a schematic section through the security document on the line X-X of FIG. 1 being viewed at a first viewing angle;

FIG. 7 is a schematic view similar to FIG. 6 with the security document being viewed from a more oblique viewing angle;

FIG. 8 is a schematic section through a security document during the blind embossing step;

FIG. 9 is a plan view of a security device bearing a simple image;

FIG. 10 is a schematic view of a security document incorporating the device of FIG. 9 when viewed in reflection at a first viewing angle;

FIG. 11 is a schematic view of the security document of FIG. 10 when viewed in reflection at a second oblique viewing angle; and

FIG. 12 is a plan view of another alternative security device.

FIG. 13 is a schematic plan view of a security document incorporating an optically variable transitory embossed image;

FIG. 14 is an enlarged view of the optically variable transitory embossed image of FIG. 13;

FIG. 15 is a schematic view of the security document of FIG. 13 being viewed in reflection from a first viewing angle;

FIG. 16 is a schematic view of the security document being viewed in reflection from a more oblique viewing angle;

FIG. 17 is a schematic view of the security document being viewed in reflection from another oblique viewing angle;

FIG. 18 is a schematic section through the security document on the line X-X of FIG. 13;

FIG. 19 is a schematic section through a security document incorporating a modified security device in accordance with the invention;

FIG. 20 is a schematic section through a security document incorporating another modified security device according to the invention;

FIG. 21 is a schematic section through a security document incorporating another modified security device in accordance with the invention;

FIG. 22 is a schematic section through a security document incorporating yet another modified security device according to the invention;

FIG. 23 is a diagrammatic view illustrating the principles of macro and micro embossment onto a substrate;

FIG. 24 is a schematic view illustrating the principles of macro and micro embossment producing a first micro embossed image;

FIG. 25 is a perspective view of FIG. 24, except illustrating a second micro embossed image;

FIGS. 26A to 26H illustrate the first phase of manufacturing an intaglio plate for macro embossings;

FIGS. 27A to 27M illustrate schematically the second phase of manufacturing an intaglio plate for macro and micro embossings; and

FIGS. 28A to 28I illustrate a laser engraving process for manufacturing an engraving plate for macro and micro embossings.

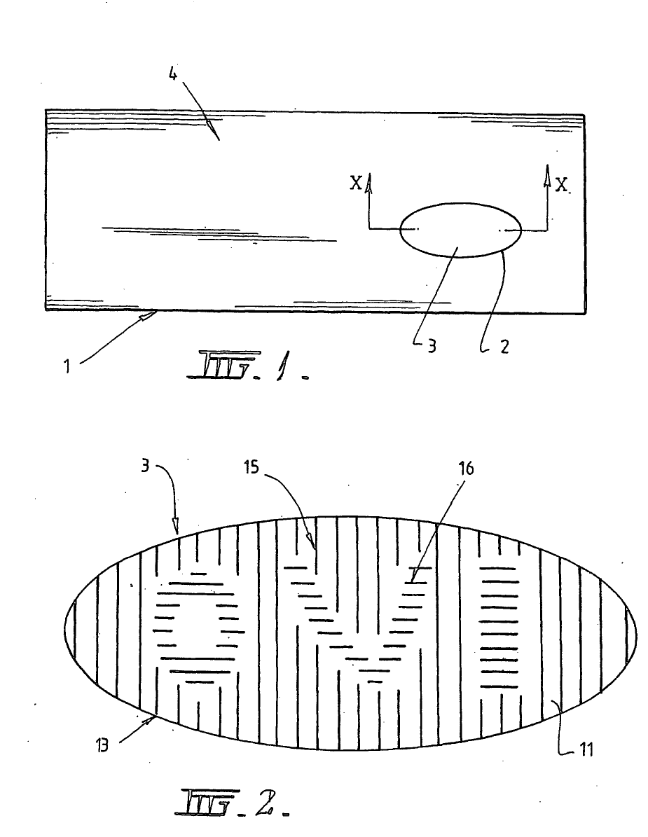

FIGS. 1 to 5 show a rectangular security document 1, such as banknote, having a transparent window 2 in which is provided a security device 3 in the form of a transitory embossed image. The remaining region 4 of the security document is substantially opaque. The opaque region 4 is printed with indicia.

As shown in FIG. 6, the security document 1 of FIG. 1 is preferably formed from a substrate 10 of transparent plastics material with opacifying layers 14 on both sides of the substrate 10 except in a portion 12 on the first side of the substrate 10. The portion 12 forms the transparent window 2 in the security document. Preferably, the transparent plastics material forming the substrate 10 is a laminated film of biaxially oriented polymeric material, such as disclosed in Australian patent no. 558476 (AU-87665/82). It will, however, be appreciated that the security document 1 may be formed from other materials, eg a substantially opaque paper or plastics substrate with a piece of transparent plastics material inserted into the substrate to form the transparent window 2.

The opacifying layers 14 preferably comprise a coating of a substantially opaque ink applied to opposite surfaces of the substrate 10, although it will be appreciated that other opacifying layers may be used. For example, a transparent plastics substrate may be sandwiched between layers of substantially opaque paper or plastics material.

Referring more particularly to FIGS. 2 and 6, the security device 3 comprises a reflective layer 11 of metallic or optically variable pigment applied to an area 13 of the substrate 10 which is embossed with sets of embossed lines 15, 16 extending in different directions to form a transitory embossed image. As shown in FIG. 2, the area 13 is elliptical in shape. The first set of embossed lines 15 extend transversely across the longitudinal axis of the elliptical area 13, and the second set of embossed lines 16 extend parallel to the longitudinal axis of the elliptical area 13. The first set of embossed lines 15 form a first part, the background, and the second set of embossed lines 16 form a second part, the letters OVI, of the transitory variable embossed image.

The reflective layer 11 may be comprised of metallic ink 11. Two suitable systems (silver and gold) are described below.

The formulations and gravure engraving specifications are as follows:
Silver coloured reflective Patch,
Eckart Aluminium (PCA)-18% Syloid 308-0.5-1.0%
Resin (two pack polyurethane system)-35% Catalyst-5.3%
MIBK-3%
Add Ethyl Acetate to achieve a printing viscosity of 21-23 secs. using Zahn cup No. 2.

Gold coloured reflective patch,
Eckart Gold (Rotoflex, Resist Grade Rich Pale Gold)-31%
Resin (two pack polyurethane system)-29% MIBK-3%
Syloid 308-0.51.0% Catalyst-4.4%
Add Ethyl Acetate to achieve a printing viscosity of 21-23 secs. using Zahn cup No. 2

The cylinder configuration used for these pigments is:
Wall=10 μmWidth=200.1838 μm
Channel=36 μm Cell Depth=57.78807 μm
Lines/cm=59 μm Stylus=120°
Screen=41.2 μm

Alternatively, an optically variable pigment may be used in the present invention instead of metallic ink. The optically variable pigment may comprise a nacreous or pearlescent pigment, such as iriodin. Another preferred type provides a colour shift between two distinct colours with the colour shift being dependent upon viewing angle. Such optically variable inks may be made by producing an optically variable thin film structure using layers of metallic or high refractive materials (eg certain metal oxides or metal sulphides) and dielectric materials, grinding the film into micro flakes and adding the flakes to an appropriate ink medium. Another method for the production of an optically variable pigment which incorporates a totally reflecting layer made by physical vapour deposition from aluminium alloy is disclosed in EP0984043 of SICPA Holding SA.

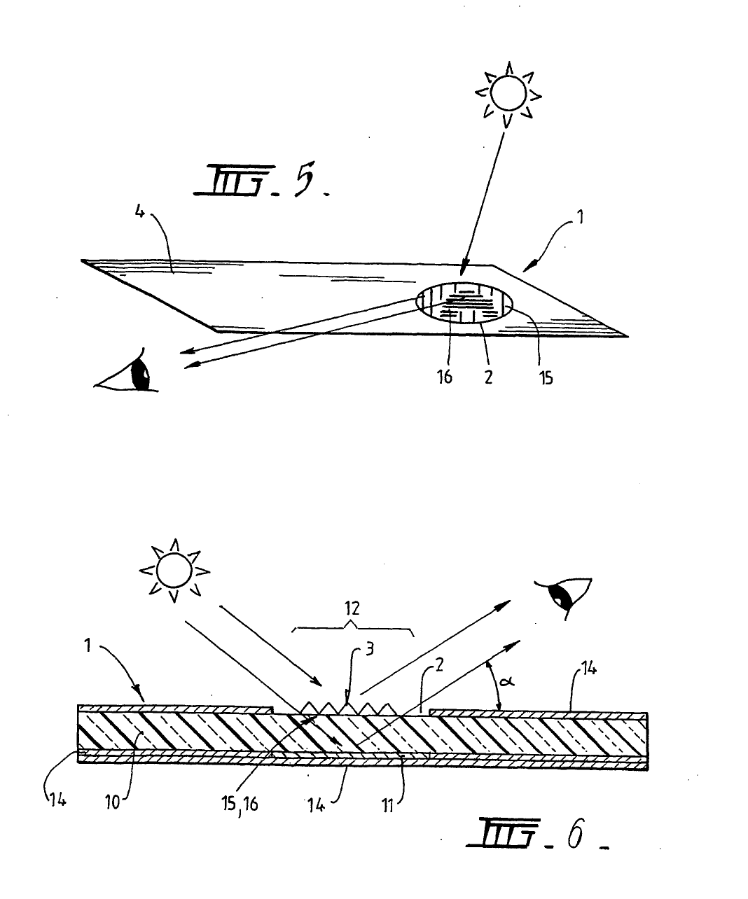

As shown in FIG. 6, a transitory embossed image 3 is formed within the window 2 of the security document 1. While FIGS. 6 and 7 illustrate a section through x-x of FIG. 1, FIGS. 6 and 7 may also be representative of a section through the security device 3 illustrated in FIG. 9 in which a simple image 30 is embossed into the security document against a plain un-embossed background 32. When the document is viewed at an angle α within a range of angles of high reflection around the perpendicular, otherwise known as a “window” of high reflection (FIGS. 6 and 10), the reflective metallic ink produces relatively coherent reflections. Similarly, the external surface of the transparent substrate 10 will also produce relatively coherent reflections, except where the surface is interrupted by the pattern of the embossed image. The embossed image 30 will cause some scattering of the light reflectance and transmittance. To some extent, depending upon the embossing process, the surface of the metallic ink will also be interrupted by the embossments causing some scattering of the reflected light. This slightly specular scattering of the light is of high contrast to the relatively coherent reflections from the remainder of the surface of the transparent substrate 10 and the reflective metallic ink 11. This contrast causes the embossed image 30 to be visible.

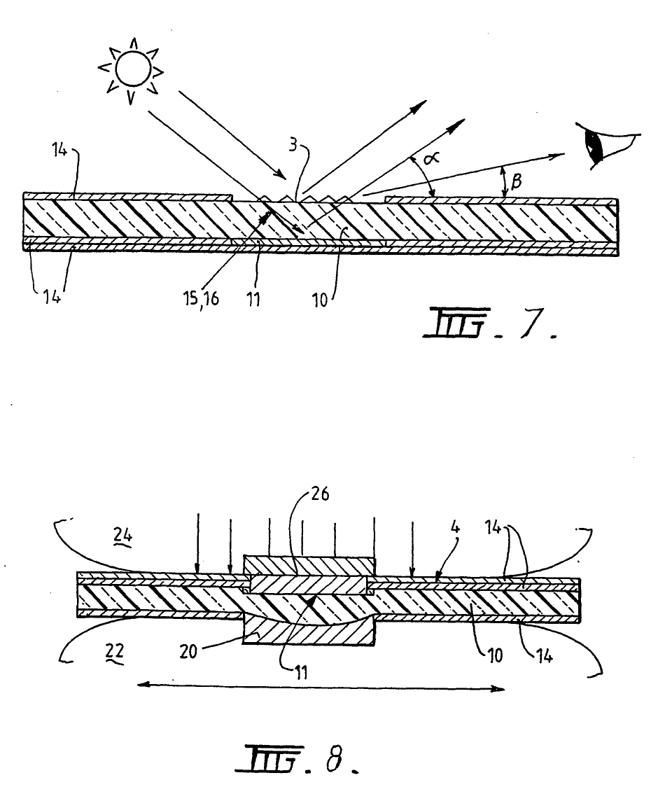

When the document is viewed at angles outside the range of angles or “window” of high reflection, e.g. at an oblique angle β as shown in FIG. 7 and FIG. 11, the reflective metallic ink will have a dull appearance. Likewise the non-embossed part of the surface of the transparent substrate 10 will not have a glossy appearance. The reflection from the embossed image produces only slight specular scattering of the light at oblique viewing angles. Therefore, the appearance of the embossed image will not be in contrast to the relatively dull appearance of the reflective metallic ink 11 and as a result, the embossed image 30 will be substantially invisible. Thus, the embossed image 30 is a transitory image which appears to switch on and off depending upon the angle of viewing.

The transitory effects exhibited by the embossed image forming the security device 3 of FIGS. 1 and 2 will now be described with reference to FIGS. 3 to 5.

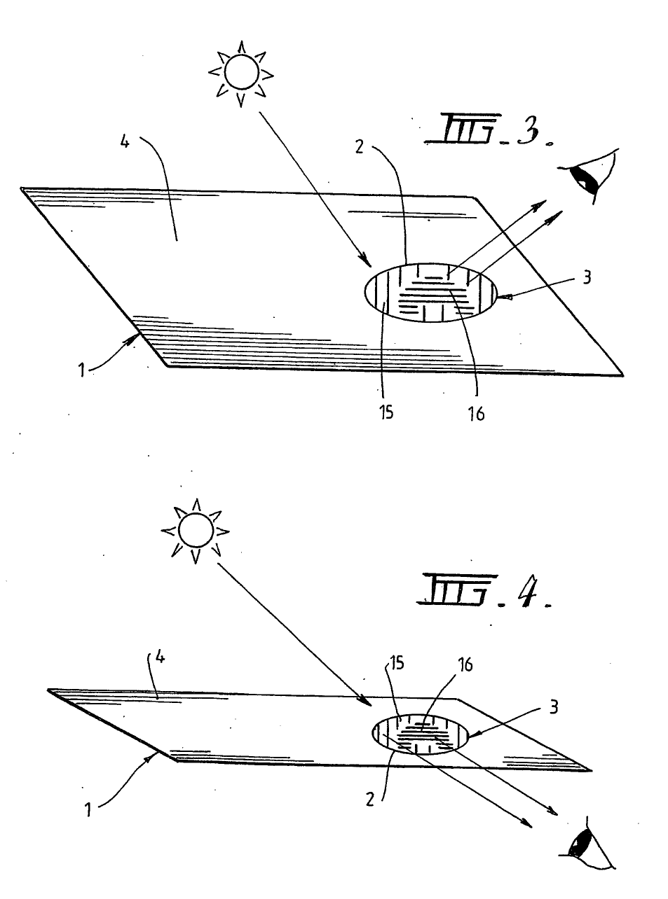

FIGS. 3 and 4 show the security device 3 being viewed in reflection at different angles through a rotation in a plane substantially perpendicular to the substrate and to the direction of the longitudinal lines of the second set of embossed lines 16. When the security device is viewed at angles within a window of high reflection around the perpendicular to the plane of the substrate as shown in FIG. 3, the reflected light from the first set of embossed lines 15 appears bright due to a high degree of reflection from the parallel lines. The light is reflected from the peaks of the embossed structure. The second set of embossed lines 16 reflect light to a lesser degree and appear darker or duller. Thus, the transitory image is visible at those viewing angles due to a contrasting colour level of brightness. As the viewing angle increases from the perpendicular to an oblique viewing angle as shown in FIG. 4, the part of the image formed by the first set of embossed lines 15 extending parallel to the direction of rotation changes to being dull, because this angle is outside the window of high reflection and due to the orientation of the lines towards the viewer, reflected light is not visible at this angle. The part of the image formed by the second set of embossed lines 16 extending perpendicularly to the viewing direction changes to being brighter because of visible scattering due to the perpendicular orientation of the lines and thus creates a more striking appearance. Thus, the transitory image (the letters OVI) formed by the second set of embossed lines 16 becomes highly visible at this oblique viewing angle owing to the contrast between the letters OVI formed by the second set of lines 16 and the duller background formed by the first set of embossed lines 15.

At certain angles between the viewing angles within the window of high reflection of FIG. 3 and the oblique angle of FIG. 4, both sets of lines 15, 16 reflect light in an equal measure and thus the transitory embossed image will be essentially invisible.

FIG. 5 shows the security device being viewed in reflected light at an oblique viewing angle in a direction substantially parallel to the second set of lines 16 and perpendicular to the first set of lines 15. From this viewing angle, the part of the image formed by the first set of embossed lines 15, which are now perpendicular to the viewing direction, has changed to being bright due to the viewer being at an optimum angle for viewing scattering of light reflected from the perpendicular lines 15. The part of the image formed by the second set of embossed lines 16, which are now parallel to the viewing direction, has changed to being comparatively dull since the angle is outside the window of high reflection and additionally, the viewer sees little scattering at the angle. Once again, the transitory image (the letters OVI) formed by the second set of embossed lines 16 is visible at this viewing angle owing to the contrast between the different sets of embossed lines 15 and 16.

When the oblique viewing angle changes from the oblique angle of FIG. 4 to the oblique angle of FIG. 5, ie in a horizontal plane substantially parallel to the plane of the substrate, the transitory image disappears because at intermediate viewing angles both parts of the image formed by the first and second sets of embossed lines appear the same colour/brightness at that angle.

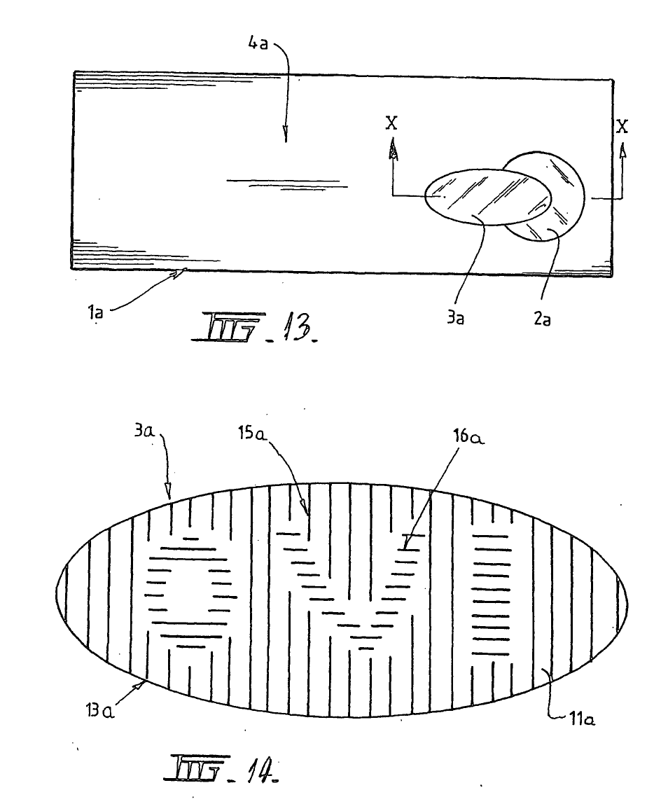

The changing patterns of bright and dull as the security document is moved through different angles create a visual effect which cannot be reproduced by normal photocopying machines. Thus, the visual effect serves as a useful security feature easily distinguishable/recognisable by the general public. Other enhanced visual effects can be achieved through the use of optically variable pigment as will be described with reference to FIGS. 13 to 19, and also through the use of macro and micro embossings as will be described with reference to FIGS. 20 to 27.

In a preferred method of manufacturing a security document or a security device such as described with reference to FIGS. 1 to 7, the layer of reflective ink or optically variable pigment 11 is applied to one side of the substrate 10 in the area where the security device 3 is to be located in a printing operation, e.g. by silk screen printing, offset or gravure printing. Then, the opacifying layers 14 are applied to opposite surfaces of the transparent substrate 10 eg by printing over region 4 of the substrate. This step could also be done after the step of creating the embossment. The area of the substrate 10 containing the layer of reflective ink or optically variable pigment 11 is embossed, engraved or otherwise deformed to form the transitory embossed image.

As shown in FIG. 8 the embossing step is performed by applying pressure to at least one side of the substrate in an intaglio printing operation in which raised printed lines are applied to at least one side of the substrate 10 in the opaque region 4. However, the embossing in the region of the optically variable ink is a blind embossing, i.e. no ink 11 is applied in the region of the reflective ink 11. The embossing step is performed on the opposite side of the substrate 10 to the side on which the layer of reflective ink 11 is applied. This has the benefit of reducing the likelihood of the ink layer 11 cracking. As shown, the embossing is performed by passing the substrate through the nip of an intaglio press having a plate cylinder 22 including an engraving 20 and an impression cylinder 24 for applying pressure. The engraving 20 on the plate cylinder 22 faces the second side of the transparent substrate opposite to the first side on which the reflective layer 11 is applied. The impression cylinder 24 has a part with a compliant surface 26 opposite the engraving 20 so that when the second side of the substrate 10 opposite the reflective layer 11 is deformed by the engraving 20, the first side of the substrate 10 and the reflective layer 11 are embossed through the transparent substrate 10 to a similar extent.

In the embodiment described in connection with FIGS. 1 to 5, the transitory image may be formed by embossed lines formed in the substrate, the lines having a predetermined height H and a predetermined spacing S. The height H may vary from a minimum of about 5 microns to a maximum corresponding to the maximum embossable height of the substrate. The spacing S depends on the height and the ratio S:H is typically from about 6:1 to 2:1. The embossed lines are therefore macro embossings, in contrast to lines of a diffraction grating or hologram which typically have a height and spacing of at least an order of magnitude smaller.

FIG. 12 is a plan view of an alternative security device 40. The reflective layer of the device 40 is made up of two colours with a silver images 42 in the shape of a moon and a gold background 44. The gold background 44 may relate to the shape of the silver image 42 or alternatively be an independent image.

Either one or preferably both of the silver image 42 and the gold background may be embossed with lines or dots in the same manner described with reference to FIGS. 1 to 11 to form a transitory embossed image. For example, the silver image 42 may be embossed with lines extending parallel to the longitudinal axis of the elliptical security device 40 and the gold background 44 may be embossed with lines extending transversely to the longitudinal axis of the security device 40. It will be appreciated that the different parts of the security device, i.e. the silver moon 42 and the gold background 44 appear brighter or duller as the security device 40 is viewed in reflection at different angles either within the range of angles or “window” of high reflection, or at oblique angles outside the window of high reflection. Also, different parts of the image appear brighter or duller and appear to switch on and off as the security device 40 is viewed from different viewing angles parallel or perpendicular to the longitudinal or transverse lines of the embossed transitory image.

It will be apparent from the description above that the present invention provides a security device which has some unusual visual effects. A security document incorporating such a security device is also difficult for counterfeiters to reproduce. It would not be possible to reproduce the effects of the transitory embossed image by colour photocopying, and a counterfeiter would require access not only to an appropriate transparent polymeric substrate, but also the specific reflective ink used by the document printing authority and appropriate embossing apparatus in order to produce a counterfeit document.

It will also be appreciated that various modifications and alterations may be made to the embodiments described above without departing from the scope and spirit of the present invention. For example, the transitory embossed image may be formed by at least one set of embossed dots, which extend in lines substantially parallel to other lines of dots in the set. Also, the area of reflective ink may extend outside the area which is embossed with the lines or dots. Further, the area of reflective ink and the embossed transitory image may extend over part of the transparent windows 2 and over part of the opaque region 4 surrounding or adjacent to the window 2. Preferably, the embossed image is formed by at least two sets of embossed lines or dots extending at different angles to one another. It will also be appreciated that more than two sets of embossed lines or dots may be provided to form a more complex transitory embossed image with different parts of the image appearing at different oblique angles.

FIGS. 13 to 17 show a rectangular security document 1a, such as banknote, which is provided with a transparent window 2a and a security device 3a in the form of an optically variable transitory embossed image. The remaining region 4a of the document 1a outside the transparent window 3a is substantially opaque. The opaque region 4a is printed with indicia. The optically variable transitory embossed image forming the security device 3a preferably overlaps part of the transparent window 2a and part of the surrounding opaque region 4a.

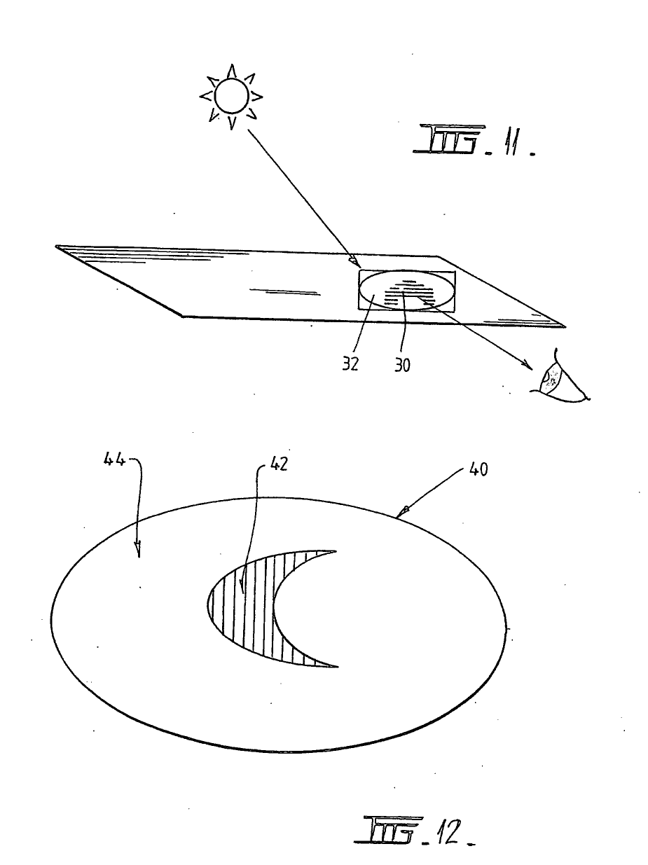

As shown in FIG. 18, the security document 1a of FIG. 13 is preferably formed from a substrate 10a of transparent plastics material with an opacifying layer 14a on both sides of the substrate 10a except in a region 12a which forms the transparent window 2a in the security document. Preferably, the transparent plastics material forming the substrate 10a is a laminated film of biaxially oriented polymeric material, such as disclosed in Australian patent no. 558476 (AU-87665/82). It will, however, be appreciated that the security document 1a may be formed from other materials, eg a substantially opaque paper or plastics substrate with a piece of transparent plastics material inserted into the substrate to form the transparent window 2a.

The opacifying layer 14a preferably comprises a coating of a substantially opaque ink applied to opposite surfaces of the substrate 10a, although it will be appreciated that other opacifying layers may be used. For example, a transparent plastics substrate may be sandwiched between layers of substantially opaque paper or plastics material.

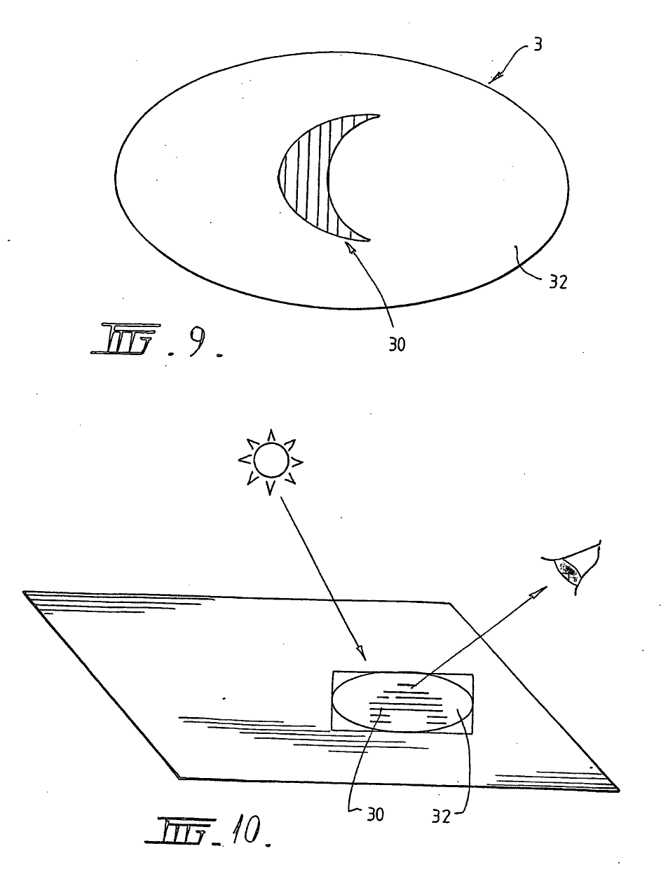

Referring more particularly to FIGS. 14 and 18, the security device 3a comprises a layer of optically variable pigment 11a applied to an area 13a of the substrate 10a which is embossed with sets of embossed lines 15a, 16a extending in different directions to form an optically variable transitory embossed image. As shown in FIG. 14, the area 13a of optically variable pigment is elliptical in shape, the first set of embossed lines 15a extend transversely across the longitudinal axis of the elliptical area 13a, and the second set of embossed lines 16a extend parallel to the longitudinal axis of the elliptical area 13a. The first set of embossed lines 15a form a first part, the background, and the second set of embossed lines 16a form a second part, the letters OVI, of the optically variable embossed image.

The optically variable pigment used is preferably a coating composition in the form of an optically variable ink, which provides a colour shift between two distinct colours with the colour shift being dependent upon viewing angle. Such optically variable inks may be made by producing an optically variable thin film structure using layers of metallic or high refractive materials (eg certain metal oxides or metal sulphides) and dielectric materials, grinding the film into micro flakes and adding the flakes to an appropriate ink medium. Another method for the production of an optically variable pigment which incorporates a totally reflecting layer made by physical vapour deposition from aluminium alloy is disclosed in EP0984043 of SICPA Holding SA. These type of optically variable pigments and inks are distinguished from metallic inks and coatings which have a reflecting metallic appearance and from optically variable inks of the pearl lustre type which present a conspicuous pearl lustre effect in reflection, while in transmission the substrate takes an unmistakable complementary hue. In such optically variable inks of the pearl lustre type, the colour shift with the angle of observation is small.

The unusual colour effects exhibited by the embossed transitory image forming the security device 3a of FIGS. 13 and 14 will now be described with reference to FIGS. 15 to 17 in which λ₁, denotes the wavelength of a first colour of the optically variable ink (eg green) and λ₂ denotes the wavelength of a second colour of the optically variable ink (eg blue).

FIGS. 15 and 16 show the security device 3a being viewed in reflection at different angles through a rotation in a plane substantially perpendicular to the substrate and to the direction of the longitudinal lines of the second set of embossed lines 16a. When the security device is viewed at angles around the perpendicular to the plane of the substrate as shown in FIG. 15, the light is diffuse and both parts of the image formed by the first and second sets of embossed lines 15a and 16a appear the same colour λ₁ (eg green). Thus, the image is substantially hidden at those viewing angles. As the viewing angle decreases from the perpendicular to an oblique viewing angle as shown in FIG. 16, the part of the image formed by the first set of embossed of lines 15a extending parallel to the direction of rotation changes colour λ₂ with the optically variable ink (eg from green to blue), while the part of the image formed by the second set of embossed lines 16a extending perpendicularly to the viewing direction remains the same original colour λ₁ (eg green). Thus, the transitory image (the letters OVI) formed by the second set of embossed lines 16a becomes highly visible at this oblique viewing angle owing to the contrast between the first colour λ₁ (eg green) of the letters OVI formed by the second set of lines 16a and the second colour λ₂ (eg blue) of the background formed by the first set of embossed lines 15a.

FIG. 17 shows the security device being viewed in reflected light at an oblique viewing angle in a direction substantially parallel to the second set of lines 16a and perpendicular to the first set of lines. From this viewing angle, the part of the image formed by the first set of embossed lines 15a, which are now perpendicular to the viewing direction, has changed colour to λ₁ (eg green) whereas the part of the image formed by the second set of embossed lines 16a, which are now parallel to the viewing direction, has changed colour to λ₂ (eg blue). Once again, the transitory image (the letters OVI) formed by the second set of embossed lines 16a is highly visible at this viewing angle owing to the contrast between the observed colours A, and λ₂ (eg green and blue) of the different sets of embossed lines 15a and 16a.

When the oblique viewing angle changes from the oblique angle of FIG. 16 to the oblique angle of FIG. 17, ie in a horizontal plane substantially parallel to the plane of the substrate, the transitory image disappears because at intermediate viewing angles both parts of the image formed by the first and second sets of embossed lines appear the same colour λ₂ (eg blue) as the optically variable ink at that angle.

Also, as the viewing angle increases towards the perpendicular through a rotation in a plane substantially perpendicular to the substrate and to the direction of the transverse lines of the first set of embossed lines 15a, the latent image becomes substantially hidden again because the parts of the image formed by the first and second sets of embossed lines 15a and 16a appear the same colour λ₁.

As shown in FIGS. 13 to 18, the optically variable transitory embossed image 13a forming the security device 3a overlaps the transparent window 2a and the opaque region 4a of the security document 1a. This also creates an unusual optical effect in that the colour changing effects of the portion of the transitory embossed image provided in the area of the transparent window 2a are visible in reflected light from both sides of the security document, whereas the colour changing effects of the portion of the transitory embossed image provided on the opaque region 4a are only visible in reflected light from one side of the security document 1a, that is the side on which the layer of optically variable pigment 11a has been applied.

A further unusual visual effect is observed when the portion of the transitory embossed image 13a in the area of the transparent window 2a is observed in transmitted light. When an optically variable ink (OVI) of the kind produced by SICPA Holding SA is applied to a transparent substrate, the striking colour changing effects seen in reflected light are not observable in transmitted light instead the OVI can appear as a dull grey colour in transmitted light irrespective of the viewing angle, and the portion of the transitory embossed image provided on the OVI in the area of the transparent window is substantially invisible when observed in transmitted light, once again forming a latent image which is only observable at certain angles in reflected light.

While FIGS. 13 to 18 show the transitory embossed image 3a overlapping the transparent window 2a and the opaque region 4a, it will, however, be appreciated that the transitory embossed image in accordance with the invention could be provided solely within a transparent window 2a of the security document 1a, solely on the opaque region 4a, or even on a completely opaque substrate or security document. The transitory embossed image could also be provided in a “half window”, such as illustrated in FIGS. 6 and 7.

FIG. 19 shows a modified embodiment in which a security device 3a in the form of an optically variable transitory embossed image 13a is provided completely within the transparent window 2a of a security document 1a.

The security device 3a of FIG. 19 is formed in the same manner as described with reference to FIG. 18, except that the layer of optically variable pigment 11a is applied to an area of the substrate 10a totally within the transparent window 2a, and only that area of the substrate 10a is embossed with sets of lines 15a, 16a so that the optically variable transitory embossed image 13a does not extend to or overlap the opacifying layer 14a forming the opaque region 4a of the security document. As described above, the transitory image 13a formed by the sets of embossed lines is a latent image which is substantially invisible in transmission, and which is only clearly visible in reflected light at certain oblique viewing angles.

In a preferred method of manufacturing a security document or a security device such as described with reference to FIGS. 13 to 19, the opacifying layers 14a are applied to opposite surfaces of the transparent substrate 10a, eg by printing, over region 4a of the substrate 10a to form the transparent window 2a, the layer of optically variable pigment 11a is then applied to one side of the substrate 10a in the area where the security device 3a is to be located in a printing operation eg by silk screen printing, offset or gravure printing, and finally the area of the substrate 10a containing the layer of optically variable pigment 11a is embossed, engraved or otherwise deformed to form the sets of embossed lines 15a and 16a to form the optically variable transitory embossed image. The embossing step may be performed by applying pressure to at least one side of the substrate in a stamping operation or in an intaglio printing operation in which raised printed lines are applied to at least one side of the substrate 10a in the opaque region 4a. Preferably, the embossing step is performed on the opposite side of the substrate 10a to the side on which the layer of optically variable ink 11a is applied to reduce the likelihood of the ink layer 11a cracking.

In a simple embodiment the transitory image may be formed by embossed lines formed in the substrate, the lines having a predetermined height H and a predetermined spacing S. The H may vary from a minimum of about 5 microns to a maximum corresponding to the maximum embossable height of the substrate. The spacing S depends on the height and the ratio S:H is typically from about 6:1 to 2:1.

It will be apparent from the description above that the embodiments described above using an optically variable ink provide a security device which has some unusual visual effects. A security document incorporating such a security device is also difficult for counterfeiters to reproduce. It would not be possible to produce the effects of the optically variable transitory embossed image by colour photocopying, and a counterfeiter would require access not only to an appropriate transparent polymeric substrate, but also the specific optically variable ink used by the document printing authority and appropriate embossing apparatus in order to produce a counterfeit document.

It will also be appreciated that various modifications and alterations may be made to the embodiments described above without departing from the scope and spirit of the present invention. For example, the transitory embossed image may be formed by at least one set of embossed dots, which extend in lines substantially parallel to other lines of dots in the set. Also, the area of optically variable pigment may extend outside the area which is embossed with the lines or dots. In this case, a single set of embossed lines or dots may be provided, with the image formed by the set of embossed lines or dots appearing a different colour to the surrounding area of optically variable ink when viewed in reflection at an oblique angle in a plane perpendicular to the direction of the embossed lines or dots; the image appearing the same colour as the background of optically variable ink when viewed in reflection at an oblique angle in a plane parallel to the direction of the embossed lines or dots. Preferably, however, the embossed image is formed by at least two sets of embossed lines or dots extending at different angles to one another. It will also be appreciated that more than two sets of embossed lines or dots may be provided to form a more complex transitory embossed image with different parts of the image appearing at different oblique angles. It is also envisaged that the unusual visual effects of the present invention could be obtained by directly printing a transitory embossed image using an optically variable ink during the intaglio process.

FIGS. 20 to 23 indicate three further modified forms of a security device 41, 42, 43 respectively which may be incorporated into a security document or security article. In each embodiment, the security document or article is comprised of a transparent substrate in the form of a transparent polymer film 44. In the first form of the security device 41 shown in FIG. 20, opacifying ink 45 is applied to a first side of the substrate so as to define a window 46. On a second side of the substrate 44 in register with the window 46 is a layer of reflective metallic ink 47. Further layers of opacifying ink 45 are applied to the second side of the substrate 44, completely covering the second side of the substrate so that the window 46 is half-window as shown. Embossment 48 is applied to a first side of the substrate 44 in a manner which will be explained more fully below.

In the second form of the security device 42, the reflective metallic ink 47 is instead applied to the first side of the substrate 44. The embossment 48 is applied from a side of the substrate 44 bearing the reflective metallic ink. A coating may be applied over the reflective metallic ink 47 below embossment 48.

In the third alternative form of the device 43 shown in FIG. 22, the opacifying layers are applied to the first and second side so as to leave a window 46 on the first side in register with the window on the second side, thereby forming a full window. The reflective metallic ink layer 47 is applied to the first side of the substrate 44 within the window 46. The embossment 48 is formed from the first side of the substrate 44. In this form of the security device 43, the effect of the embossment can be viewed through the substrate from the second side of the substrate 44 as well as from the first side.

In each of the devices 41, 42, 43 described briefly above, the embossment is in the form of macro embossments 52, 53 whereby micro embossments 54A, 54B are formed on portions of the macro embossments 52, 53.

Referring to FIG. 23, a simple explanation of the principle of macro and micro embossing is provided. Any of the sheets of FIGS. 20 to 22 are depicted schematically as sheet 50, which has been macro-embossed with a series of parallel embossed lines 52, 53 having a height of about 20 μm and a spacing of about 80 μm, each macro-embossed line 52, 53 having a micro-embossing in the form of lines or dots 54 to a height of about 2 μm to about 5 μm formed on its sides, such that the micro-embossing 54 is visible when viewed at angles equal or greater than α (14.5°), and is hidden when viewed at angles less than β (7.2°) as illustrated.

In the embodiments of FIGS. 20 to 22, the micro embossments are formed so as to bear two different images at different viewing angles. As can be seen from FIG. 23, each of the macro embossments 52, 53 have first corresponding walls 55 and second corresponding walls 56. As can be seen in FIG. 24, the first corresponding walls 55 have micro embossments 54A disposed thereon such that when viewed from an angle A as shown facing the first corresponding walls 55, a first micro image 58A will appear at predetermined viewing angles.

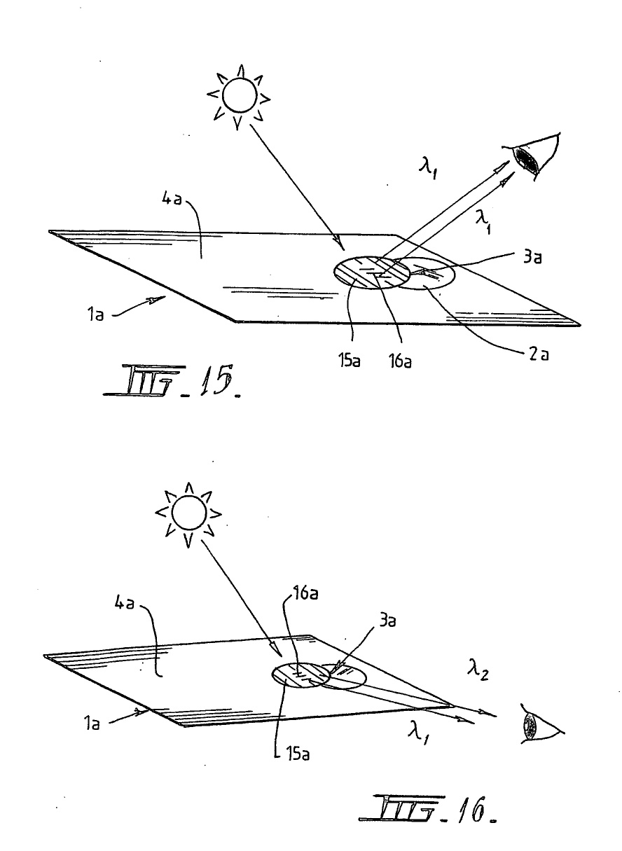

Additionally, as illustrated in FIG. 25 the second corresponding walls 56 have micro embossments 54B. When the device is viewed from a second direction B as shown facing the second corresponding walls 56, the micro embossments 54B will form a second image 58B which becomes visible at certain predetermined angles.

In the embodiment of FIG. 20, a great complexity may be achieved from the macro and micro embossing due to the combination of the transparent substrate 44 and the reflective metallic ink. In these embossments, the reflective metallic ink is embossed through the transparent polymer film so that there will be scanning of light where the embossments interrupt the plane of the metallic ink as well as scattering of light where the embossments interrupt the reflective plane of the upper surface of the transparent substrate 44. This leads to some complex effects.

FIGS. 20 to 25 exhibit a particular effect, with varying degrees of effectiveness. The reflections from the reflective metallic ink layer 47 and the transparent substrate 44 create reflections such that the first micro image, then the second micro image can be seen from viewing directions facing the first walls 55, by switching through different viewing angles relative to the plane of the sheet. Similarly, the second micro image, then the first micro image can also be viewed from viewing angles facing the second corresponding walls 56, by switching through different viewing angles relative to the plane of the sheet. The security device 41 provided in a “half window” or shown in FIG. 20 appears to show the best switching effects. On the other hand, the full window of FIG. 22 does not exhibit as good switching effects although each images can still be seen at different angles from both facing directions.

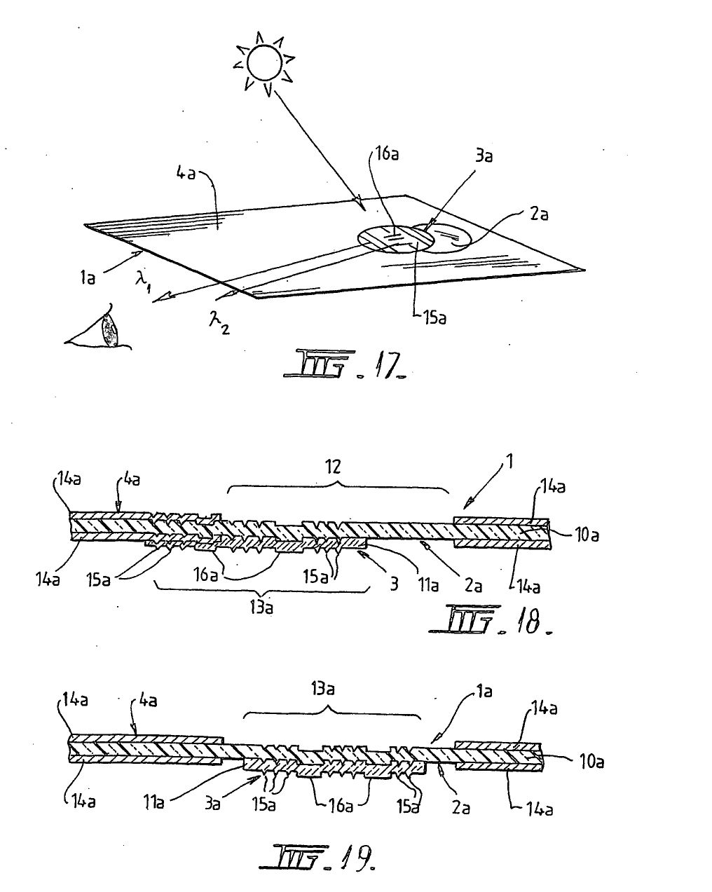

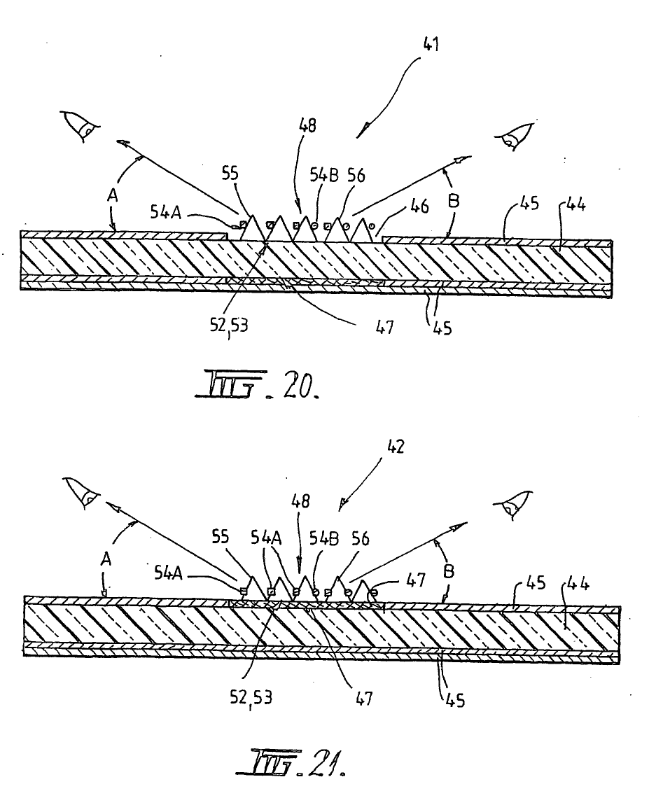

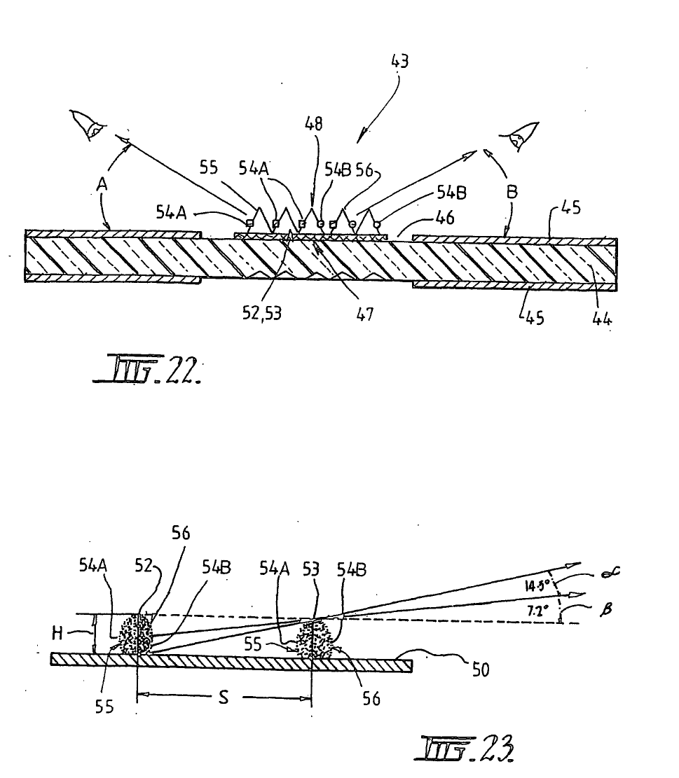

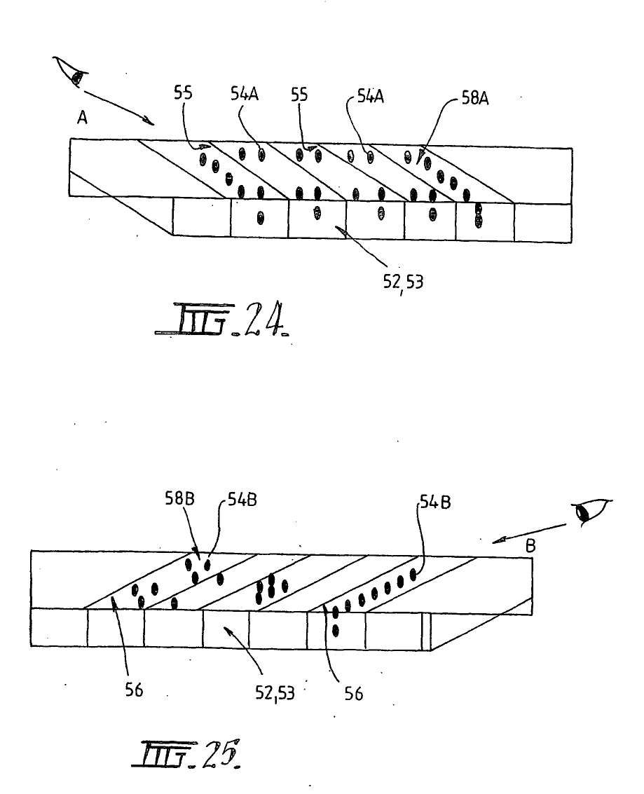

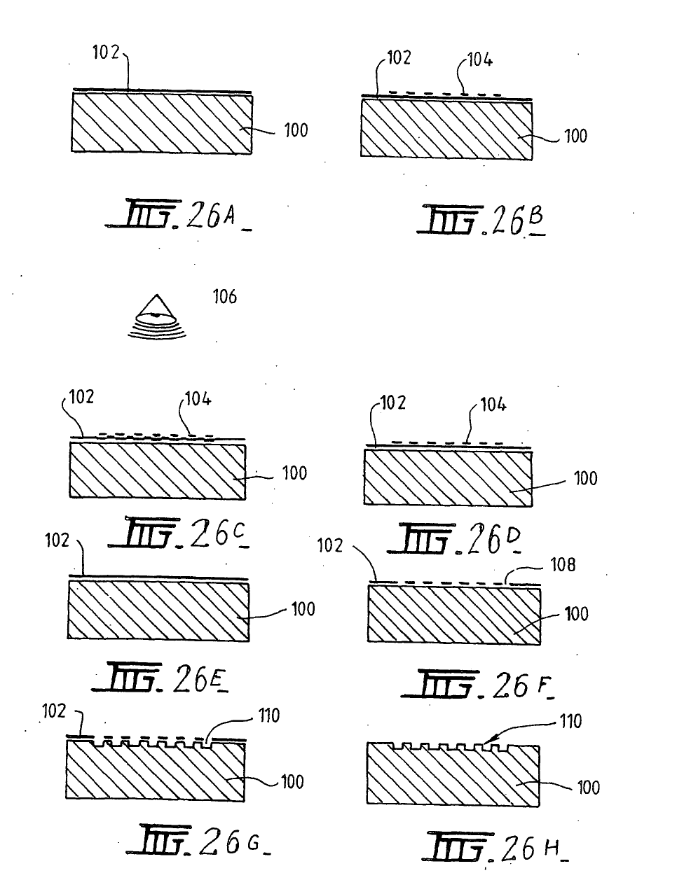

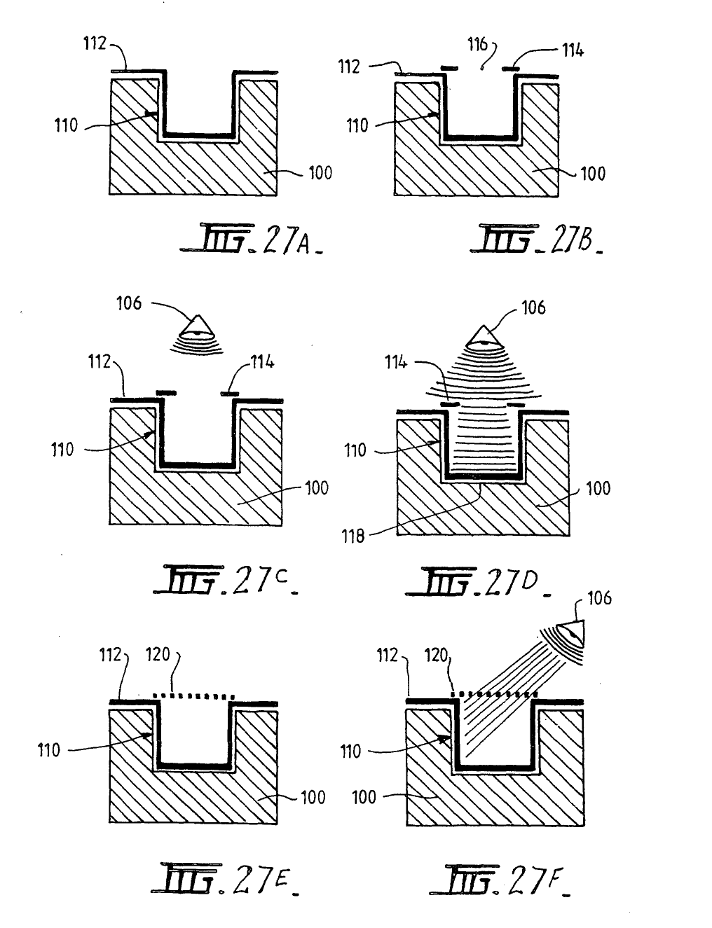

The macro and micro embossing may be created by the process of hot stamping or embossing through an inkless intaglio process, otherwise known as blind embossing. The stamping plate or intaglio plate may be derived from a metal plate created in the following fashion shown in FIGS. 26 and 27;
1. Spin photo-resist polymer 102 over a copper metal plate 100 at an even thickness of up to 3 μm (FIG. 26A).
2. Position the macro-emboss mask 104 over the photo-resist polymer 102 (FIG. 26B).
3. Irradiate the surface with radiation from one or more UV lamps (FIG. 26C).
4. Remove the UV lamps (FIG. 26D).
5. Remove the macro-emboss mask 104 (FIG. 26E).
6. Dissolve and wash away the unexposed photo-resist polymer 108 (FIG. 26F).
7. Using a ferric chloride and copper solution, etch the macro-emboss structure 110 (FIG. 26G).
8. Remove the photo-resist polymer 102 (FIG. 26H).
   If desired the process can be preformed in opposite photo-resist, using negatives instead of positives.

FIGS. 27A to 27M illustrate a micro-embossing process, which involves the following steps:
1. Using the same plate as was used for the macro-embossing, spin photo-resist polymer 112 over the metal plate 100, ensuring the resist enters at an even thickness into the macro-embossed structure 110, as shown in FIG. 27A.
2. Position a revised macro mask 114 into the same position as the original 0 macro mask. The revised macro mask will have the centre 116 of all the macro-embossed lines removed (FIG. 27B).
3. Irradiate the surface with UV radiation from one or more UV lamps 106. This should be performed to ensure the non-engraved sections of the plate and the bottom section 118 of the macro-embossed lines are exposed (FIGS. 27C and D).
4. Remove the UV lamps 106.
5. Remove the revised macro-emboss mask 114.
6. Position the first micro-embossing mask 120 over the photo-resist (FIG. 27E). Mask 120 consists of an elongated image. The image is elongated such that when viewed at the preferred optimum viewing angle of about 30°, the image appears in scale.
7. Irradiate the surface with UV radiation from one or more UV lamps 106 (FIG. 26F). The UV lamps should be placed at the optimum viewing angle of about 30° to the horizontal. These lamps must irradiate a uniform light in order to create a required exposure pattern on the photo-resist 121 on one side 111 of the macro embossings 110 as shown in FIG. 27F.
8. Remove the UV lamps.
9. Remove Mask 120 (FIG. 27G).
10. Position the second micro-embossing mask 130 over the photo-resist FIG. 27H). Mask 130 also consists of an elongated image, with an optimum viewing angle of 30°. Mask 130 may consist of a different image to Mask 120.
11. Irradiate the surface with UV radiation from one or more UV lamps 106. The UV lamps should be placed at the optimum viewing angle of about 30° to the horizontal, in the opposite direction as for Mask 120, in order to create a required exposure pattern on the photo-resist 123 on the other side 113 of the macro-embossing 110 as shown in FIG. 27I.
12. Remove the UV lamps.
13 Remove Mask 130 (FIG. 27J).
14. Dissolve and wash away the unexposed photo-resist 125 on the sides 111, 113 of the macro-embossing 110 (FIG. 27K).
15. Using hydrochloric acid, etch the micro-emboss structures 141, 143 on the side 111, 113 of the macro-embossed structure 110 (FIG. 27L).
16. Remove the photo-resist polymer) FIG. 27M).

In the above process, both the micro-mask 120 and the micro-mask 130 consist of elongated images. The extent of the elongation is predetermined by the preferred viewing angle. The preferred viewing angle has been set at about 300 to the document.

Elongation Ratio: x/y=1/sin (gamma)

x=elongated length of image on substrate

y=image viewing height

With an optimum viewing angle of 30°, the extent of elongation is 2:1. For example, if an image has a viewing height of 15 mm. then the image created by the micro-mask will be 30 mm long on the substrate. The image is only to be elongated in the vertical viewing direction.

Following the above processes, the intaglio plate for achieving the macro and micro-embossing may be made by the following steps:
1. A nickel metal plate is grown from the copper plate.
2. The nickel plate is pressed into a sheet of PVC.
3. PVC titles are cut out and welded into the greater intaglio design. The directional embossing images are usually a subset of an overall intaglio design.
4. The metal printing plate is manufactured from the welded PVC master-tiles.
5. Intaglio printing is performed as described in WO 94/29119. Some areas of the intaglio plate may be inked as for traditional intaglio printing. The area of the intaglio plate which is intended for the directional emboss feature will not be inked.

The embossing process is a continuous process whereby the substrate to be embossed is passed through two rolling cylinders under high pressure. The embossed intaglio plate covers one of the two cylinders, the other cylinder is the impression cylinder. During the process, the substrate is forced into etchings of the plate by the impression cylinder. The substrate plastically deforms into the shape of the etchings. When the substrate exists the rolling cylinders, the macro-emboss reflexes partially back into shape, due to the nature of the material. The embossing on the substrate remains intact. However, the height of the embossing does not equal the height of the etching on the plate, a typical ratio is about 1:5. For this reasons the maximum foreseeable final emboss on the relaxed substrate is about 35-40 μm.

The intaglio process has some restriction as to the temperature range within which the process may be used. The process of hot stamping may be used at higher temperatures.

It will be appreciated from the foregoing that the intaglio printing plate created is a negative printing plate having recessed engravings to create the embossments. For a hot stamping process, it is proposed to use stamping tools having raised engravings. Instead of a series of grooves to form the macro embossments as in the intaglio plate, the hot stamping plate may comprise a series of raised lines. The micro embossments can therefore be formed on the sides of the raised lines. It is also possible for the micro-embossings on the macro-embossings to be formed in a laser engraving process.

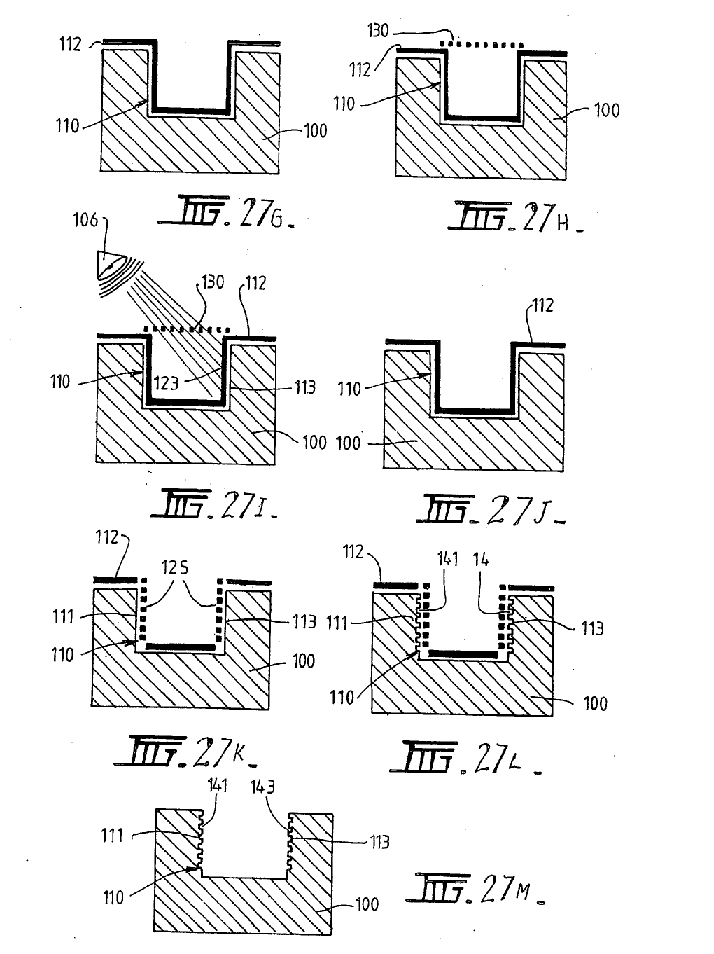

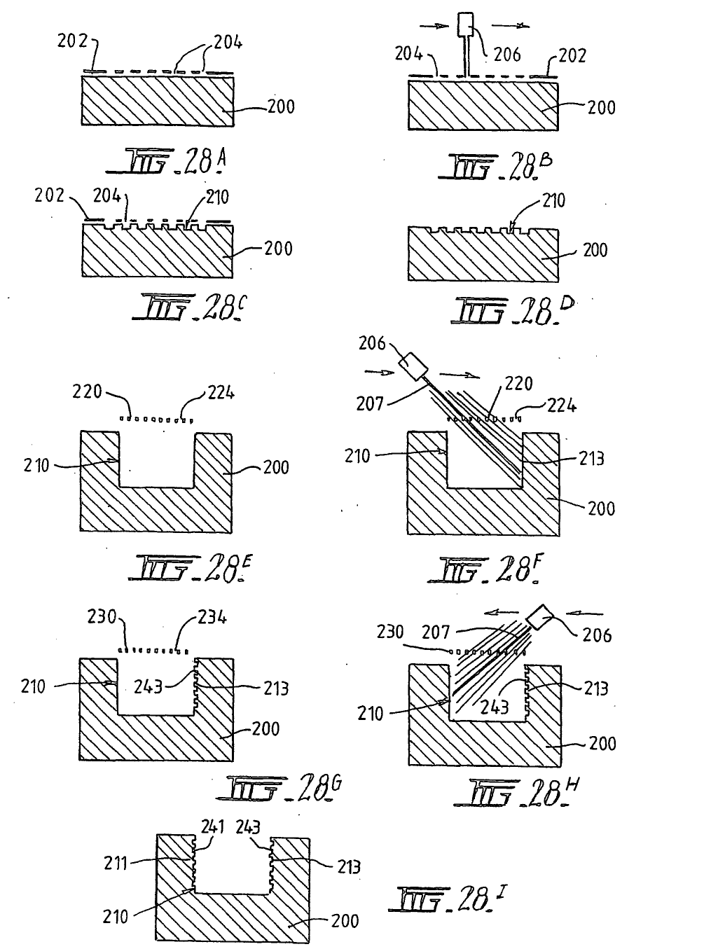

FIGS. 28A to 28I illustrate schematically a laser engraving process for forming micro-embossings or macro-embossings which involves the following steps:
1. A macro-embossing mask 202 having openings 204 is placed over a metal plate 200 to be engraved. (FIG. 28A).
2. A scanning laser 206 passes over the metal plate 200 to ablate areas of the metal plate 200 below the openings 204 in the mask 202 to form the macro-embossings 210 (FIGS. 28B and 28C).
3. The macro-embossing mask 204 is removed (FIG. 28D).
4. A first micro-embossing mask 220 is placed over the macro-embossing 210 (FIG. 28E).
5. A scanning laser 206 is directed at an angle to the micro-embossing mask 220 and surface of the metal plate 200. As the scanning laser 206 travels across the surface of the metal plate 200, the laser beam 207 passes through openings 224 in the micro-embossing mask 220 to ablate parts of one side 213 of the macro-embossing 210 to form micro-embossings 243 on that side 213 of the macro-embossing 210 (FIGS. 28F and 28G).
6. The first micro-embossing mask 220 is then removed and replaced with a second micro-embossing mask 230 having openings 234 (FIG. 28G)
7. The scanning laser 206 is then directed at an angle to the second micro-embossing mask 230 in the opposite direction as for mask 220. As the scanning laser 206 travels across the surface of the metal plate 200, the laser beam 207 passes through the openings 234 in the mask 230 to ablate parts of the opposite side 211 of the macro-embossing 210 to form micro-embossings 241 on that side 211 of the macro-embossing 210 (FIG. 28H).
8. The second micro-embossing mask 230 is then removed (FIG. 28I).

The above process may be used to form micro-embossings 241,243 on a macro-embossed structure 210 in a metallic layer of a security device or security document. More preferably the process is used to form a metal intaglio printing plate for achieving macro- and micro-embossings in an intaglio printing process in a similar manner to that described above.

FIGS. 28A to 28I show a laser engraving process used to form micro-embossings on the sides of generally rectangular macro-embossings. It will, however, be appreciated that the macro-embossings may take other shapes. For instance, the macro embossings may be generally triangular in shape, as illustrated schematically in FIGS. 20 to 22. In this case, it is not necessary for the scanning laser 206 to be directed at an angle to the surface of the metal plate 200 when engraving the micro-embossings 241,243 on the sides 211,213 of the triangular macro embossings. Instead, the laser 206 can be directed perpendicularly to the surface of the metal plate.

It will be apparent that the embodiments described above which have micro-embossings formed or macro-embossings on a reflective background provide a security device which has unusual visual effects. A security document incorporating such a security device is also difficult for counterfeiters to reproduce. It would not be possible to produce the effects of the transitory embossed micro images by colour photocopying, and a counterfeiter would require access not only to an appropriate transparent polymeric substrate, but also the specific reflective ink used by the document printing authority and appropriate micro-embossing apparatus in order to produce a counterfeit document.

It will also be appreciated that various modifications and alterations may be made to the embodiments described above without departing from the scope and spirit of the present invention. For example, the macro-embossings of the transitory embossed image may be formed by at least one set of embossed dots, which extend in lines substantially parallel to other lines of dots in the set. Also, the area of reflective ink may extend outside the area which is embossed with the lines or dots. Further the transitory embossed image may extend outside the window or half window into the opaque area surrounding the half window. Also, the transitory embossed image with micro embossings on macro-embossings may be provided on a background of optically variable ink instead of metallic ink.

1. A method of forming a security device including:
providing a sheet including a substantially transparent or translucent layer and a reflective layer, at least part of the reflective layer being visible through at least a portion of the transparent or translucent layer from a first side of the sheet; and blind embossing the sheet at least partly within said portion from the first side of the sheet, through the transparent or translucent layer and onto the reflective layer to form a transitory embossed image within said portion.

2. A method of forming a security device according to claim 1, wherein the substantially transparent or translucent layers are in permanently fixed disposition to each other within the sheet.

3. A method of forming a security device according to claim 1, wherein the portion of the transparent or translucent layer is defined by only partly opacifying the sheet to form a window in the sheet; and wherein the sheet is blind embossed at least partly within the window from the first side of the sheet, through the transparent or translucent layer and onto the reflective layer to form a transitory embossed image at least partly within said window.

4. A method of forming a security device according to claim 1 including the further step of only partly opacifying the sheet to define said portion of the transparent or translucent layer as a window in the sheet.

5. A method of forming a security device including providing a substantially transparent or translucent layer, blind embossing from a first side of the substantially transparent or translucent layer through the transparent or translucent layer to produce an embossment in the layer;
applying a reflective layer to the other side of said substantially transparent or translucent layer at least in part register with—the embossment, thereby resulting in a transitory embossed image in the reflective layer visible through the transparent or translucent layer at least at some viewing angles.

6-8. (canceled)

9. A method according to claim 1 wherein the substantially transparent or translucent layer comprises transparent polymeric substrate with the reflective layer applied to one side or embedded into the polymeric substrate.

10. A method according to claim 1 wherein the substantially transparent or translucent layer comprises a coating applied to a substrate.

11-13. (canceled)

14. A method according to claim 1 wherein the reflective layer is formed by printing with a reflective ink, comprising a highly reflective metallic ink, such as a silver or gold metallic ink, or a nacreous or pearlescent pigment.

15-16. (canceled)

17. A method according to claim 14 wherein the reflective layer is formed by printing with a reflective ink of the type comprising an optically variable pigment which provides a color shift between two distinct colors with the color shift being dependent upon the viewing angle.

18-19. (canceled)

20. A security device comprising a sheet including: a reflective layer; a substantially transparent or translucent layer, the layers being in permanently fixed disposition to each other within the sheet; a blind embossed transitory image formed through the substantially transparent or translucent layer onto the reflective layer, at least part of which is visible through the transparent or translucent layer at least at some viewing angles.

21. A security device according to claim 20 wherein the transitory embossed image is visible at viewing angles within a range of angles of high reflection.

22. A security device according to claim 20 wherein at least one side of the sheet is partly opacified to define a window in the sheet, the transitory image being disposed at least partly within the window.

23-35. (canceled)

36. A security device according to claim 20 wherein the transitory embossed image includes a first set of embossed lines or dots extending in one direction, and a second set of embossed lines or dots extending in a different direction.

37. A method or security device according to claim 36 wherein the second set of embossed lines or dots extends substantially perpendicularly to the first set of embossed lines or dots.

38. A security device according to claim 20 wherein the transitory embossed image comprises a first embossing having a predetermined feature and a second embossing of smaller dimensions formed on said predetermined feature of said first embossing, said first embossing being formed to hide and reveal said second embossing at predetermined viewing angles.

39-59. (canceled)

60. A security device comprising:
a sheet including a reflective layer, and a blind embossed transitory image formed in the sheet in the region of the reflective layer,
wherein the transitory embossed image comprises a first embossing having a predetermined feature and a second embossing of smaller dimensions formed on said predetermined feature of said first embossing, said first embossing being formed to hide and reveal said second embossing at predetermined viewing angles.

61. A security device according to claim 60 wherein the sheet includes a transparent or translucent layer and the sheet is embossed through the transparent or translucent layer forming the transitory embossed image in the reflective layer.

62. A security device according to claim 61 wherein the reflective layer is visible through the transparent or translucent layer.

63. A security device according to claim 60 wherein the sheet is only partly opacified to define a window in the sheet, the transitory image being disposed at least partly within the window.

64-77. (canceled)

78. A security document or device comprising: a substrate; a layer of optically variable pigment applied to an area of the substrate, wherein the optically variable pigment provides a color shift between two distinct colors with the color shift being dependent upon the viewing angle; and an embossed transitory image formed by an embossing in the area of optically variable pigment, wherein the embossed transitory image includes a first set of lines or dots extending in one direction and a second set of lines or dots extending in a different direction.

79-90. (canceled)

91. A security document or device comprising a substrate, a layer of optically viable or reflective coating applied to an area of the substrate, and an embossed transitory image formed by embossing in the area of the optically variable or reflective coating, wherein the security document is formed with a transparent window and the embossed transitory image is at least partly disposed in the transparent window.

92-98. (canceled)
